(19) United States
(12) Patent Application Publication
(10) Pub. No.: US 2012/0054218 A1
(43) Pub. Date: Mar. 1, 2012

(54) METHOD AMD SYSTEM FOR RAIL YARD INVENTORY MANAGEMENT USING WEB-BASED ACCESS TECHNOLOGY

(75) Inventors: Hung Ha, Houston, TX (US); Hoa Ha, Houston, TX (US)

(73) Assignee: E. I. Systems, Inc., Houston, TX (US)

(21) Appl. No.: 12/868,269

(22) Filed: Aug. 25, 2010

(51) Int. Cl. G06F 15/16; G06F 17/30

(52) U.S. Cl. 707/769; 709/204; 707/E17.014

(57) ABSTRACT

The present invention is a web-based rail yard inventory system. This invention provides a user with the ability to access the rail yard management information from any computing that can access a computing network. This invention provides the capability to monitor and modify railcar locations in a rail yard, generate email alerts and rail car reports that are shown on a display screen to a client. In the configuration of this invention, a server device contains software applications for clients with equipment in a particular rail yard. The rail yard is the manager of the inventory system and maintains in the system software related to each client with equipment in the rail yard.

### FIELD OF THE INVENTION

The present invention relates to a method and system for managing rail yard inventory and in particular to a method and system for rail yard inventory management using web-based network technologies that enable a user client to access rail yard inventory information from any computing device that is capable of accessing and connecting to the Internet.

### BACKGROUND OF THE INVENTION

Computer networks, satellites, telephone systems and communication networks such as the Internet provide many tools to communicate information. As a result of the ability to conveniently distribute information, organizations have incorporated these technology advancements into their operations.

With the availability of modern communication networks connecting large numbers of data processing devices, an increasing number of applications or services for users are executed involving more than a single data processing device. A large number of such distributed applications are available today and may be executed on a plurality of data processing devices. Distributed applications may, for example, include office applications such as managing documents and data files, and may include visualizing information, banking services, shopping services and the like.

A distributed application or service may be executed involving a server data processing device and a client data processing device, the client data processing device being operated by a user. The server and client device interact with each other in order to achieve a common goal. This type of communication configuration, shown in FIG. 1, is referred to as a client/server configuration. In this configuration 100, part of the software for an application resides on the client machine 102 and part of the software resides on the server machine 104. The client and server are connected via a communication network 106. For security reasons, the connection of the client and server devices via the communication network requires special access protocol, wherein a user supplies certain information to verify the user's identity. The information is process to authenticate the user and to ensure that an authenticated user has the required privileges to access the requested information or resources.

In a client/server operation a user may launch a distributed application by entering a suitable instruction at the client data processing device 202. The client data processing device will then connect to the server data processing device 204 to execute the application. Some parts of modules of the application may reside on the client data processing device, whereas other parts or modules of the application may reside at the server data processing device. The distributed application requires a potentially complex cooperation between modules executed at the client data processing device and modules of the distributed application executed at the server data processing device. For example, a distributed application involving visualizing a document at the client data processing device may include (1) application modules executed at the server for processing or rendering the document in order to convert the document into a format which may be displayed at a display unit of the client, and (2) modules executed at the client data processing device for receiving frames for local display and supplying the frames to a display unit. If the user, moreover, wishes to edit the document, control information and further information to be visualized may be exchanged between the client data processing device and the server data processing device.

Another client/server configuration is when there is a direct access link between the client device and the server device. FIG. 2 illustrates this direct access or point-to-point configuration 200. The user device 202 directly connects to the server device 204. This connection 206 could be a hard-wired connection such as a cable, or wireless connection such as wireless or mobile phone network. This configuration also implements access control protocol for security reasons. Also, with this system, the client device stores part of the application software and the server device stores part of the software.

As mentioned, all of society implements some form of communication using computing devices and networks. The rail yard industry is no different. Management of rail yard equipment is an integral part of the operation of a rail yard. A rail yard is a complex series of railroad tracks for storing, sorting or loading, unloading, cleaning, and repairing railroad cars and locomotives. Rail yards have many tracks in parallel for keeping rolling stock stored off the main railroad lines, so that they do not obstruct the flow of mainline rail traffic and so that there is a readily available inventory of railcars. Cars in a rail yard may be sorted by numerous categories, such as by the owner of a car or the product it contains, by status (empty, full, clean, or dirty), by car type or product or whether the cars need repairs. Rail yards are normally built where there is a need to store cars while they are not being loaded or unloaded, or are waiting to be assembled into trains.

The large number of railcars in a rail yard and the constant entry and exit of railcars requires an efficient inventory system to manage and track all of the activities associated with the railcars in a rail yard. The railcar management activities include identifying and tracking the status and locations of the railcars in the rail yard, retaining a history of these activities and generating reports for various entities that are often at rework locations.

Current rail yard management systems have features that allow for the efficient management of equipment in a rail yard. Some systems have the capability to continuously identify in real-time the location of each railcar on a graphical map of a rail yard. These systems are designed to maximize the utilization and availability of rolling stock by tracking rail car locations, including arrivals and departures of railcars with a rail yard. Although rail yard management system currently exist, these systems are implemented through a client/server configuration that limits the ability for a client to access, monitor or modify information related to the management of equipment in a rail yard. In the current systems, a user only has access to rail yard management information through system access at specifically identified devices. The primary reason for this limitation is that modules of the management software are stored on a client machine and part of the software is stored on a server machine. This configuration is understandable in that a client needs access to their equipment being stored in a particular rail yard. However, if a particular client does not have immediate access to a client computing device containing their particular software, they cannot have immediate access to the information about their rail yard equipment. This situation is not unique to rail yard applications.

Although client/server configurations are common, there remains a need for a method and system in which a client can access information related to their equipment in a particular rail yard through any computing device that can access a rail yard management system through the Internet.

### SUMMARY OF THE INVENTION

The present invention is a web-based rail yard inventory system. This invention provides a user with ability to access the rail yard management information from any computing device that can access to a computing network using a web browser. In the configuration of this invention, a server device contains software applications for clients with equipment in a particular rail yard. The particular rail yard location manages the inventory system and maintains in the system software related to each client with equipment in the rail yard. The client also has specific information to provide when attempting to access information related to their equipment. Once the client has provided the information and authenticating processes have verified the client, the client can access rail yard information about their equipment.

In the present invention, the client and server information is contained on the network. The computing interface or terminal used by the client does not have software needed to implement the rail yard management system. As a result, the client has the flexibility to access the rail yard management system from any terminal that can connect to the communication network. The client does not share any of its resources, but requests a server's content or service function. This type of configuration is a web-based configuration that provides flexibility over the other communication configurations used to implement rail yard management systems.

### DESCRIPTION OF THE DRAWINGS

FIG. 1 is a configuration of a conventional client/server system in which a user can access a server via a communication network.

FIG. 2 is a configuration of a special access connection between a client device and a server device.

FIG. 3 is a configuration of a communication between a client device and a server device connected via web-based network.

FIG. 4 depicts data processing equipment for a system that can be utilized to implement the present invention.

FIG. 5 is a diagram of a computer network over which users can access Web servers and software user agent emulators from a remote network location.

FIG. 6 is a configuration of the web-based rail yard management system of the present invention.

FIG. 7 is an alternate configuration of the web-based rail yard management system of the present invention further comprising a car location message input interface.

FIG. 8 is a configuration of software modules contained in a server device for a rail car management system.

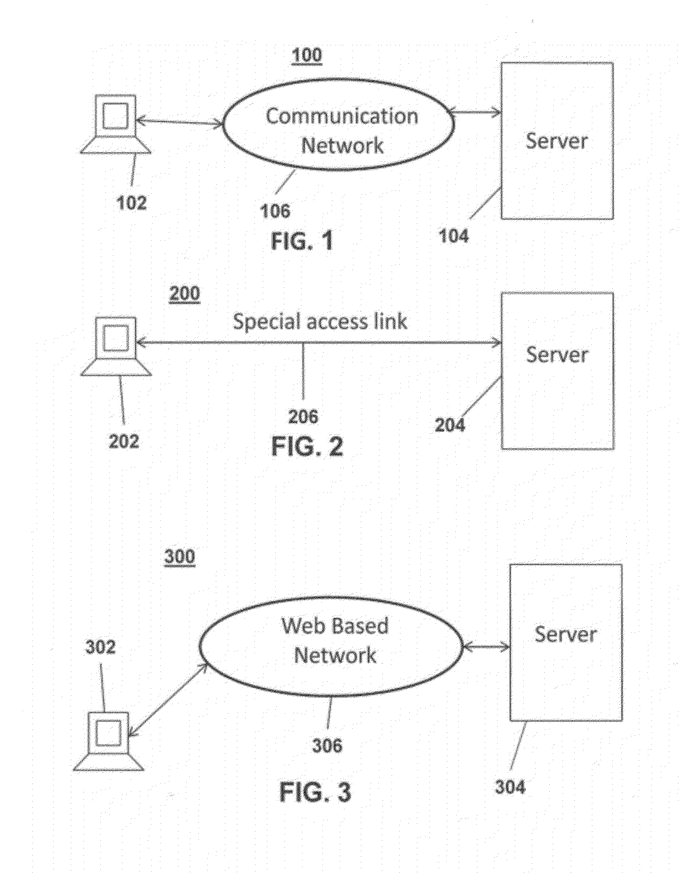

### DETAILED DESCRIPTION OF THE INVENTION

The present invention is a web-based rail yard inventory management system. A rail yard implements this inventory management system to track and monitor railcars located at the rail yard and railcars that enter and exit the rail yard. Rail yards serve as depots for freight companies that transport products. Freight companies load and unload railcars at these rail yards. In addition, many times, freight companies store railcars at the rail yards. Because there are numerous railcars at these rail yards that belong to the various companies, these freight companies can monitor the status and location of their railcars at the rail yard. To manage the inventory of railcars, the rail yard implements a rail management software programs. The present invention enables the client user to access this rail management from a web-based network.

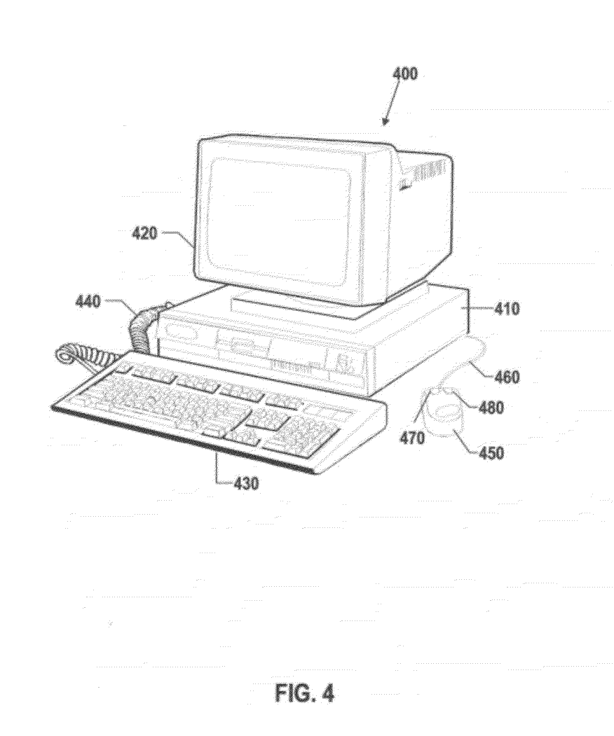

FIG. 3 is a configuration of a communication between a client device and a server device connected via web-based network for the present invention. In this configuration, the client desiring to access the rail management system uses a typical computing device 302 (See FIG. 4). A connection is established with the server 304 via a web-based network 306 such as the Internet. Access to the web-based network is through a web browser. In this configuration, the processing software for the management system resides in the server. In the conventional management configuration (client/server), the client can also access the management system via a communication network. However the portion of the management software that enables that specific client to access their information in the system resides on the client's own computing device. The client must be on that particular computing device and/or install software to access the management system. In the present invention, all management software resides in the server. As a result, the client can access the management system from any computing device that can connect to the management system via the Internet. This configuration is referred to as “web based”.

FIG. 4 depicts a pictorial representation of data processing system 400 which may be used in implementation of the present invention. As may be seen, data processing system 400 includes processor 410 that preferably includes a graphics processor, memory device and central processor (not shown). Coupled to processor 410 is video display 420 which may be implemented utilizing either a color or monochromatic monitor, in a manner well known in the art. Also coupled to processor 410 is keyboard 430. Keyboard 430 preferably comprises a standard computer keyboard, which is coupled to the processor by means of cable 440. Also coupled to processor 410 is a graphical pointing device, such as mouse 450. Mouse 450 is coupled to processor 410, in a manner well known in the art, via cable 460. As is shown, mouse 450 may include left button 470, and right button 480, each of which may be depressed, or “clicked”, to provide command and control signals to data processing system 400. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 400 may be implemented utilizing a personal computer, smart phone, or other device with computing capability and internet connection capabilities.

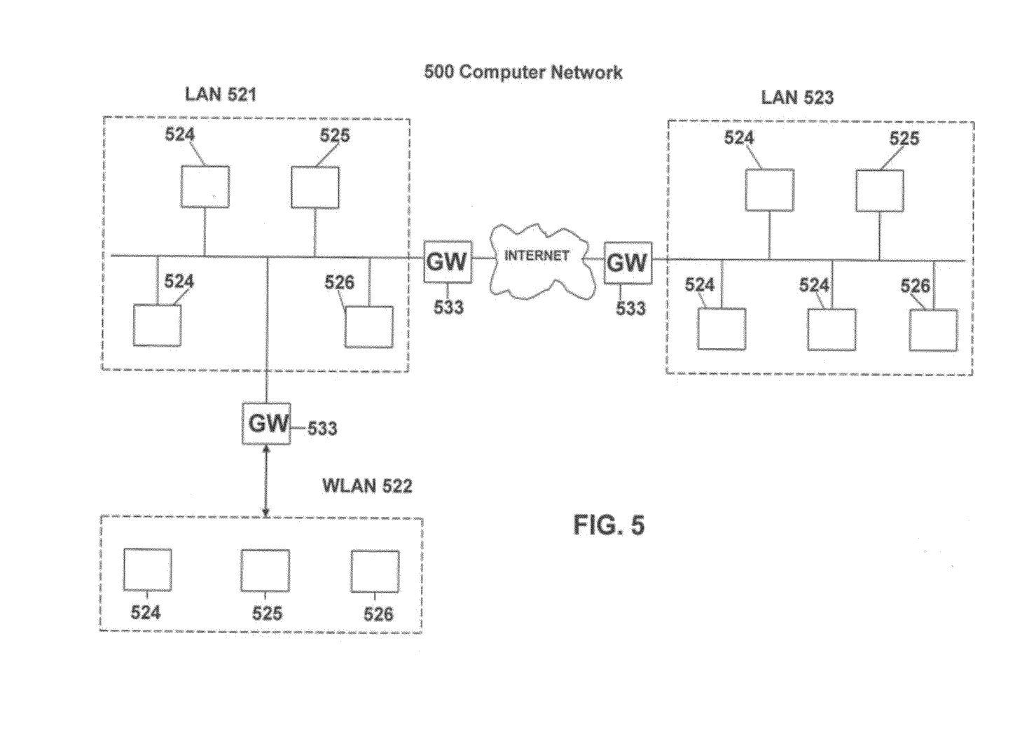

The method of the present invention may be implemented in a global computer network environment such as the Internet. With reference now FIG. 5, there is depicted a pictorial representation of a distributed computer network environment 500 in which one may implement the method and system of the present invention. As may be seen, distributed data processing system 500 may include a plurality of networks, such as Local Area Networks (LAN) 521 and 523, Wireless LAN (WLAN) 522, each of which preferably includes a plurality of individual computers. A local area network (LAN) supplies networking capability to a group of individual computers 524 in close proximity to each other such as in an office building, a school, or a home. Each LAN can be connected with other LAN, Wireless LAN or Internet by Gateway 533 which is a network point that acts as an entrance to another LAN or Internet. Any of the processing systems may also be connected to the Internet as shown. As is common in such data processing systems, each LAN may be coupled to a storage device 525 and/or a printer/output device 526. One or more such storage devices 525 may be utilized, in accordance with the method of the present invention, to store the various data objects or documents which may be periodically accessed and processed by a user within distributed data processing system 500, in accordance with the method and system of the present invention. In a manner well known in the prior art, each such data processing procedure or document may be stored within a storage device 525 which is associated with a Database, a Resource Manager or Library Service, which is responsible for maintaining and updating all resource objects associated therewith.

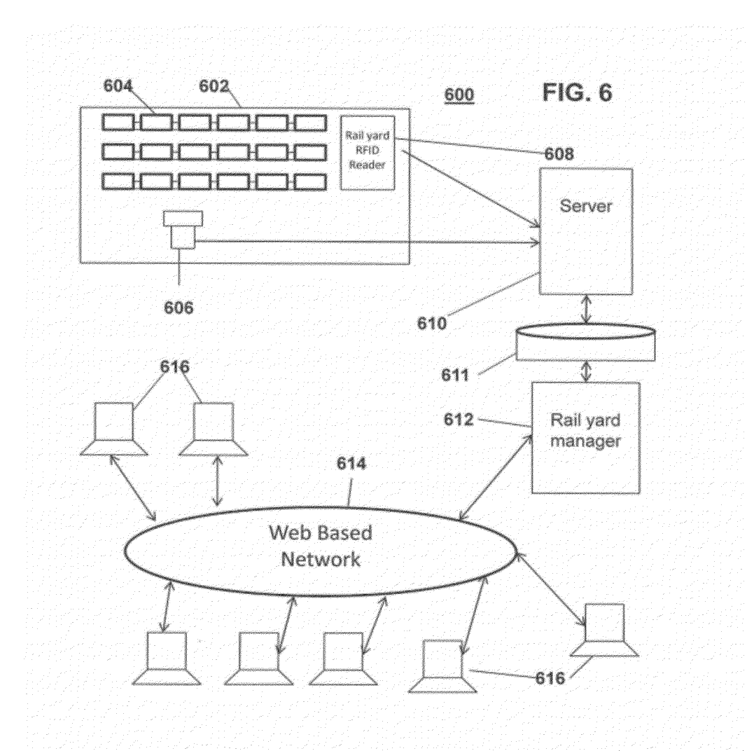

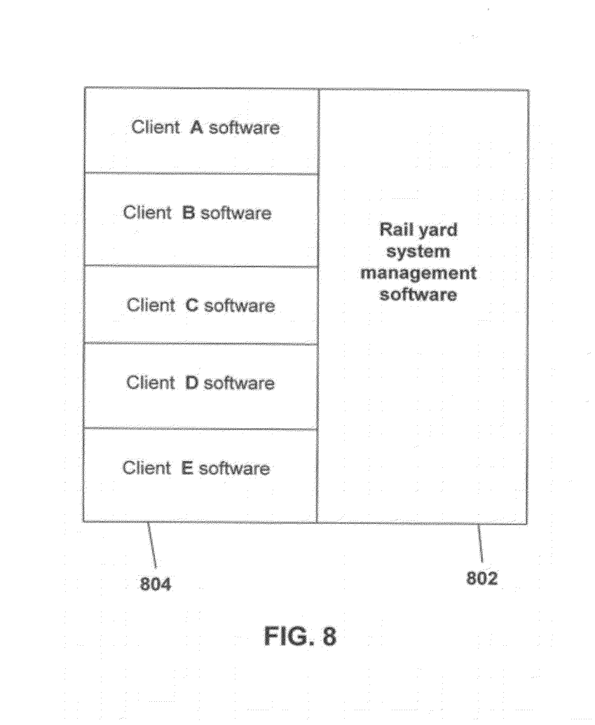

FIG. 6 shows a configuration of the rail yard management system of the present invention. Shown in this configuration 600 is the rail yard 602 containing railcars 604 on multiple tracks. Input devices such as a camera device 606 or an RFID reader 608 can capture railcar information for processing and transmission to a server device 610. The server 610 serves as a front-end processor that converts data from the input interface devices. Many times, the data from the various input devices are in different formats. The server puts them into a uniform format. One such server that performs this process is known as the “Rail Logger®”. The server device can process, verify and authenticate information received from input devices 606 and 608. The server also puts the information in a storage device 611 which is accessed by the rail yard manager application 612. The rail yard manager application, known as the “Rail Manager®”, puts the information in condition for display to clients. Depending on the configuration, it is possible for the server and rail yard manager application to be in the same computing device. The web-based network 614 provides the medium through which a client can access rail yard information. The client can access the information in the rail yard manager via the terminal devices 616. As shown, multiple terminal devices access the web based network. In the present system, because of the configuration of the software (see FIG. 8), the client can access the rail yard manager from any of the terminal devices. In the current (client/server) configuration, the client could only access to the rail yard manager through a specific terminal that contains client specific software.

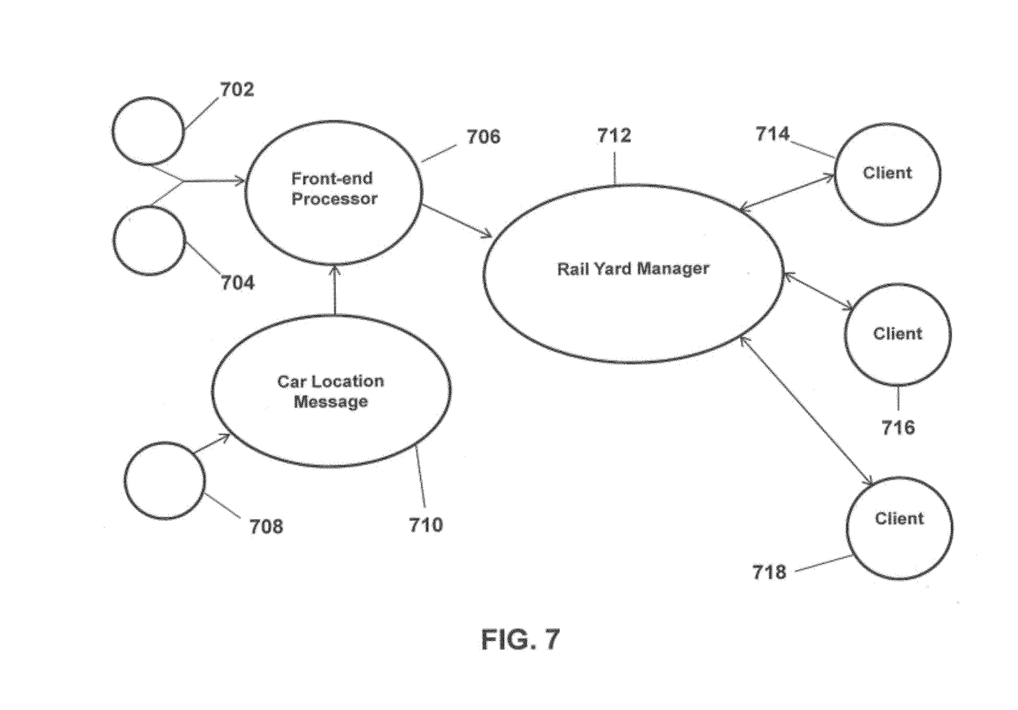

FIG. 7 shows an alternate configuration of the rail yard management system of the present invention incorporating a car location message module (CLM). This configuration has multiple interface inputs which can include a RFID gate and hand held reader 702, and a camera image capturing device 704. These input devices collect information that is transmitted to a front-end processor 706. These transmissions can occur over a local or global communication network. These transmissions can vary and can include FTP (web based), email (web based), serial data transmissions, telephone line transmissions or cellular telephone transmissions. The configuration can also have a rail car shipper 708 that sends car location messages (CLM) 710 to the front end processor 706 in the present invention. Again, this transmission can be web-based. The rail yard manager 712 receives the information from the front-end processor 706. This information can be processed and stored in a database. Clients 714, 716 and 718 can access information related to their particular equipment in a rail yard that is in the rail yard manager. These clients can access their specific information via basically any electronic device that can access the global computing network. The web-based features of the present invention make this flexible access possible. For example, client 714 can access their information in the rail yard manager through terminal 718. In conventional system, the only way for client 714 to access their information was through interface device such as described in FIG. 4.

FIG. 8 shows the software configuration for a web based implementation of the rail yard manager in the present invention. In one embodiment, the software would reside in the rail yard manager. The rail yard manager 612 houses the information about the various pieces of equipment in the rail yard. The rail yard manager also has the information in format for display to the clients. The software comprises management software programs 802 that receives information from the server device and processes that information according to predetermined parameters. The system management 802 also communicates with the client software modules 804 also residing in the rail yard manager. The client accesses the rail yard manager and communicates with the software module for that specific client. The initial process authenticates the client's identity and determines whether the client can have access the rail yard information. The client identification process can be a common process including confirming user identification and password validation. Once the client has access to its information via the client software module 804 and the system software 802, the client can view information and even modify information related to the client's equipment. With the rail management system, the client receives several benefits. For example, the client receives a pictorial representation of cars and locations. The client has the ability to import raw data from spreadsheets into the yard inventory information. The client and rail yard personnel can perform and document railcar movements by drag and drop functions. This feature reduces the need for manual entry of equipment information and thereby speeds up work flow and reduces transposition errors. Many of these features are performed via the display capabilities of the rail yard management software. Clients can perform these functions from any location without the requirement of a specific computing machine as is required with conventional rail yard management configurations.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. The invention in its broader aspects is not limited to the specific details, representative apparatus and methods, and illustrative examples shown and described. Accordingly, departures may be made from such details without departing from the spirit or scope of the applicant's general inventive concept.

We claim:

1. A system for rail yard inventory monitoring and management through a web based interface comprising:
a computing device interface at a client location to enable a client to access rail yard inventory information;
a rail yard management module for managing equipment at a rail yard location;
a global communication network to provide a connection between said computing device interface and said rail yard management module;
client software modules residing in said rail yard management module for processing client specific information;
rail yard management system software modules residing in said rail yard management module for processing received rail yard information; and
a display module for displaying to a client information related to that client's equipment located at the rail yard.

2. The rail yard management system as described in claim 1 further comprising a plurality of computing device interfaces through which a client can access said rail yard management module, said plurality of computing device interfaces not containing any specific software for accessing said rail yard management module.

3. The rail yard management system as described in claim 2 further comprising a server device in communication with said rail yard management module for receiving and processing information collected at the rail yard location.

4. The rail yard management system as described in claim 3 further comprising detection devices located at the rail yard location for collecting information about equipment information located in the rail yard, said detection devices being in communication with said server device and said detection devices capable of transmitting the detected information to said server device.

5. The system as described in claim 3 wherein said server and said rail yard manager reside at the same location.

6. The system as described in claim 3 wherein said server and said rail yard manager are housed in the same computing device.

7. The system as described in claim 1 further comprising a web browser for accessing said global communication network from said computing device interface.

8. A method for accessing, monitoring and managing rail yard inventory information through a web based interface comprising the steps of:
establishing a connection with a global communication network;
detecting an access attempt from a requester at a rail yard management website;
sending a query to the access site requester for account identification information;
receiving and verifying requester account information at the rail yard management website;
when account information is verified, query requester for search criteria;
performing a search based on the search criteria; and
displaying search results to requester over the global communication network.

9. The method as described in claim 8 wherein said search performing step further comprises determining whether requester is allowed to access information in the search criteria.
